(19) United States
(12) Patent Application Publication
(10) Pub. No.: US 2006/0058715 A1
(43) Pub. Date: Mar. 16, 2006

(54) External counterpulsation device with multiple processors

(76) Inventors: John C.K. Hui, East Setauket, NY (US); Harold Kaefer, Wyckoff, NJ (US); Terence H. Koong, Upper Saddle River, NJ (US); Robert F. Koshinskie, Cranford, NJ (US)

Correspondence Address: HARNESS, DICKEY & PIERCE, P.L.C., P.O. BOX 828, BLOOMFIELD HILLS, MI, 48303, US

(21) Appl. No.: 11/036,623

(22) Filed: Jan. 14, 2005

Related U.S. Application Data
(63) Continuation of application No. 10/941,047, filed on Sep. 14, 2004.

(51) Int. Cl. A61H 9/00

(52) U.S. Cl. 601/151; 601/150; 601/148

(57) ABSTRACT

An external counterpulsation apparatus includes a treatment table and a fluid distribution assembly operable to apply pressure to patient limbs. A first microprocessor controller disposed in the housing unit processes patient treatment data and controls application of pressure through the fluid distribution assembly. A second microprocessor controller external to the housing unit communicates with the first microprocessor controller and outputs data to a human operator. A variable frequency drive device cooperates with the first microprocessor to vary generation of a compressed fluid and distribute the compressed fluid at a flow rate corresponding to the patient treatment data. The fluid distribution assembly includes a plurality of inflatable devices interconnected with a plurality of valves, which deliver a variable flow rate of compressed fluid to the plurality of inflatable devices.

### CROSS-REFERENCE TO RELATED APPLICATIONS

This application is a continuation of U.S. patent application Ser. No. 10/941,047 filed on Sep. 14, 2004. The disclosure of the above application is incorporated herein by reference.

### FIELD OF THE INVENTION

The present invention relates to an external counterpulsation apparatus and method for controlling the same, and more particularly, to such an external counterpulsation apparatus and method for controlling the same having improved efficiency and utility.

### DISCUSSION OF THE INVENTION

External counterpulsation is a noninvasive, atraumatic means for assisting and increasing circulation in patients. External counterpulsation uses the patient's physiological signals related to their heart cycle (e.g., electrocardiograph (ECG), blood pressure, blood flow) to modulate the inflation and deflation timing of sets of compressive cuffs wrapped around a patient's calves, lower thighs and/or upper thighs, including the lower buttocks. The cuffs inflate to create a retrograde arterial pressure wave and, at the same time, push venous blood return from the extremities to reach the patient's heart at the onset of diastole. The result is augmented diastolic central aortic pressure and increased venous return. Rapid, simultaneous deflation of the cuffs at the end of diastole produces systolic unloading and decreased cardiac workload. The end results are increased perfusion pressure to the coronary artery during diastole, when the heart is in a relaxed state with minimal coronary artery resistance to blood flow; reduced systolic pressure due to the “suction effect” during cuff deflation; and increased cardiac output due to increased venous return and reduced systolic pressure.

Under normal operating conditions, when the heart contracts and ejects blood during systole, the aortic and coronary perfusion pressure increases. It should be noted that the workload of the heart is proportional to the systolic pressure. However, during systole the impedance to coronary flow also increases significantly due to the contracting force of the myocardium, thereby restricting coronary blood flow. Also, during diastole, the myocardium is in a relaxed state, and impedance to coronary flow is significantly reduced. Consequently, although the diastolic perfusion pressure is much lower than systolic pressure, the coronary blood flow during diastole accounts for approximately eighty (80) percent of the total flow.

The historical objectives of external counterpulsation are to minimize systolic and maximize diastolic pressures. These objectives coalesce to improve the energy demand and supply ratio. For example, in the case of patients with coronary artery disease, energy supply to the heart is limited. External counterpulsation can be effective in improving cardiac functions for these patients by increasing coronary blood flow and therefore energy supply to the heart.

During a treatment session, the patient lies on a table. Electronically controlled inflation and deflation valves are connected to multiple pairs of inflatable devices, typically adjustable cuffs, that are wrapped firmly, but comfortably, around the patient's calves, lower thighs, and/or upper thighs, including the buttocks. The design of the cuffs permits significant compression of the arterial and venous vasculature at relative low pneumatic pressures (200-350 millimeters Hg). Patient's receiving external counterpulsation treatments require a stable treatment table to lie on. During counterpulsation, the rapid inflation and deflation of the cuffs wrapped around the extremities of a patient may move the patient up and down, thereby inducing a sliding effect. Not only would this cause discomfort for the patient, the motion would produce motion artifacts on the electrocardiogram (ECG) and other physiological measurements such as oxygen saturation (SpO₂), blood pressure and blood flow. These potentially inaccurate measurements make the detection of physiological triggering signals, such as ECG, for synchronization of counterpulsation with the cardiac cycle very difficult, if not impossible.

Typically, the ECG signal from the patient is used as a trigger to mark the beginning of a cardiac cycle, and an earlobe pulse wave, finger pulse wave or temporal pulse wave is used to monitor the appropriate time for application of the external pressure so that the resulting pulse produced by external pressure in the artery can arrive at the root of the aorta just at the closure of the aortic valve. Thus, the arterial pulse wave is divided into a systolic period and a diastolic period. The earlobe pulse wave, finger pulse wave or temporal pulse wave signals, however, may not reflect the true pulse wave from the great arteries such as the aorta.

According to the present invention, there are two factors that should be taken into account to determine the appropriate deflation time of the inflatable devices: (1) release of all external pressure before the next systole to produce maximal systolic unloading, i.e., the maximum reduction of systolic pressure; (2) maintenance of the inflation as long as possible to fully utilize the whole period of diastole so as to produce the longest possible diastolic augmentation, i.e., the increase of diastolic pressure due to externally applied pressure. One measurement of effective counterpulsation is the ability to minimize systolic pressure, and at the same time maximize the ratio of the area under the diastolic wave form to that of the area under the systolic wave form. This consideration can be used to provide a guiding rule for determination of optimal deflation time.

Furthermore, the various existing external counterpulsation apparatuses only measure the ECG signals of the patient to guard against arrhythmia. Because counterpulsation applies pressure on the limbs during diastole, which increases the arterial pressure in diastole and may make it higher than the systolic pressure, the blood flow dynamics and physiological parameters of the human body may vary. Some of these variations are beneficial.

Existing external counterpulsation systems have separate control consoles and treatment tables. Typically the inflation/deflation valve assembly is located in the control console, and requires long tubing to connect to the inflatable cuffs on the patient lying on the treatment table. This decreases the rate of inflation and may result in pressure loss through the system. More importantly, the long hose with small diameter would reduce significantly the rate of deflation, often leaving behind residual pressure in the inflation devices, obstructing venous filling, thereby reducing venous return and the effect of external counterpulsation. Further, the assembly operates by controlling the opening and closing of solenoid valves, which until now has had the disadvantage of having voluminous and complex pipe connections and tubing. This is disadvantageous to downsizing the apparatus and improving its portability.

Accordingly, the present invention provides a unitary, or all-in-one, external counterpulsation apparatus including a stable treatment table having a built-in housing unit located under the table for all of the treatment components. This unitary assembly provides for the proximal placement of a compressor, reservoir, inflation and deflation valves, and control module. The assembly reduces pressure and energy losses, power requirements, and heat and noise generation. The housing unit provides a plurality of modular compartments, each operable to house treatment system components and adapted to be individually removed for service and mobility. Placement of the inflation/deflation assembly directly beneath the patient reduces dead space and less energy is required to achieve the required pressure during the diastolic phase of the treatment. The rate of inflation is increased without loss in transmission through long connecting tubing, and the rate of deflation is faster with reduced residual pressure.

According to another aspect of the present invention, a curvilinear treatment table is disclosed. The table includes a substantially concave upper portion operable to support the head and upper torso of a patient and a substantially convex portion operable to support the lower torso of a patient. The upper and lower portions are joined at a saddle point. The upper portion is preferably articulatable allowing selective angulation with respect to the saddle point, providing an inclination for the patient's head and upper torso.

According to yet another aspect of the current invention, an external counterpulsation apparatus is provided with a variable frequency drive device. A plurality of inflatable devices are adapted to be received about the lower extremities of a patient and are in communication with a source of compressed fluid. A fluid distribution assembly is interconnected with the inflatable devices and the source of compressed fluid. The variable frequency drive device is adapted to serve as a control module to direct the generation of compressed fluid at a variable output with a pressure and rate corresponding to the patient's physical and physiological operational parameters.

According to a further aspect of the present invention, the external counterpulsation apparatus is further provided with inflation/deflation valves having different flow rates. In this aspect, the apparatus includes a plurality of inflatable devices adapted to be received about the lower extremities of the patient, including a calf inflation device, and at least one thigh inflation device. A fluid distribution means is adapted to deliver a variable flow rate of fluid from a source of compressed fluid to the calf and thigh inflation devices.

According to a further aspect of the present invention, an external counterpulsation apparatus is provided with a treatment table assembly including a treatment table, a housing unit, and an inflation/deflation assembly operable to apply pressure to limbs of the patient. The assembly has means for retrieving a patient's physical and physiological parameters. A first microprocessor controller is disposed in the housing unit and is adapted to receive the physical and physiological parameters and to control the application of pressure using the inflation/deflation assembly. A second microprocessor controller, external from the housing unit, is adapted to serve as an interface between the first microprocessor controller and a human operator.

According to still another aspect of the present invention, a method of treating a patient with an external counterpulsation apparatus is disclosed. The method includes providing a plurality of inflatable devices adapted to be received about the lower extremities of the patient. A source of compressed fluid is interconnected with a fluid distribution assembly that distributes fluid from the source to the inflatable devices. The output of the compressed fluid source is controlled by using a variable frequency drive device to inflate the inflatable devices to a preset pressure. In one embodiment, the maximum output volume is equal to a volume required to produce the preset pressure in the inflatable devices.

According to yet another aspect of the present invention, a second method of treating a patient with an external counterpulsation apparatus is disclosed. The method includes providing a plurality of inflatable devices adapted to be received about the lower extremities of the patient. A fluid distribution assembly is interconnected with a source of compressed fluid and the inflatable devices. Compressed fluid is distributed from the fluid source to at least two of the plurality of devices through flow valves using a different flow rate.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a diagrammatic view of an external counterpulsation apparatus according to the principles of the present invention;

FIG. 2 is an isometic view of an exemplary curvilinear treatment table assembly according to the principles of the present invention;

FIG. 3 a schematic, sectional view of the treatment table assembly of FIG. 2;

FIG. 4 is a side view of the treatment table assembly of FIG. 2;

FIG. 5 is a top view of the treatment table assembly of FIG. 2;

FIG. 6 is a diagrammatic view of a prior art pressure regulation system used in counterpulsation;

FIG. 7 is a diagrammatic view of a prior art pressure regulation system used in counterpulsation; and

FIG. 8 is a diagrammatic view of the pressure regulation system used according to the principles of the present invention.

It should be noted that the diagrams and drawings of counterpulsation devices set forth herein are intended to exemplify the general characteristics of external counterpulsation embodiments among those useful in the methods of the invention, for the purpose of describing such embodiments herein. The drawings may not precisely reflect the characteristics of any given embodiment, and are not necessarily intended to define or limit specific embodiments within the scope of this invention.

### DETAILED DESCRIPTION OF THE PREFERRED EMBODIMENTS

The following description of the preferred embodiment(s) is merely exemplary in nature and is in no way intended to limit the invention, its application, or uses.

The present invention relates to an external counterpulsation apparatus and method for controlling an external counterpulsation apparatus. Such methods include the use of an external counterpulsation apparatus, and may optionally use other devices and pharmaceutical treatments. Such devices and treatments useful herein, must, accordingly, be therapeutically acceptable. As referred to herein, a “therapeutically acceptable” component is one that is suitable for use with humans and/or animals without undue adverse side effects (such as toxicity, irritation, and allergic response) commensurate with a reasonable benefit/risk ratio.

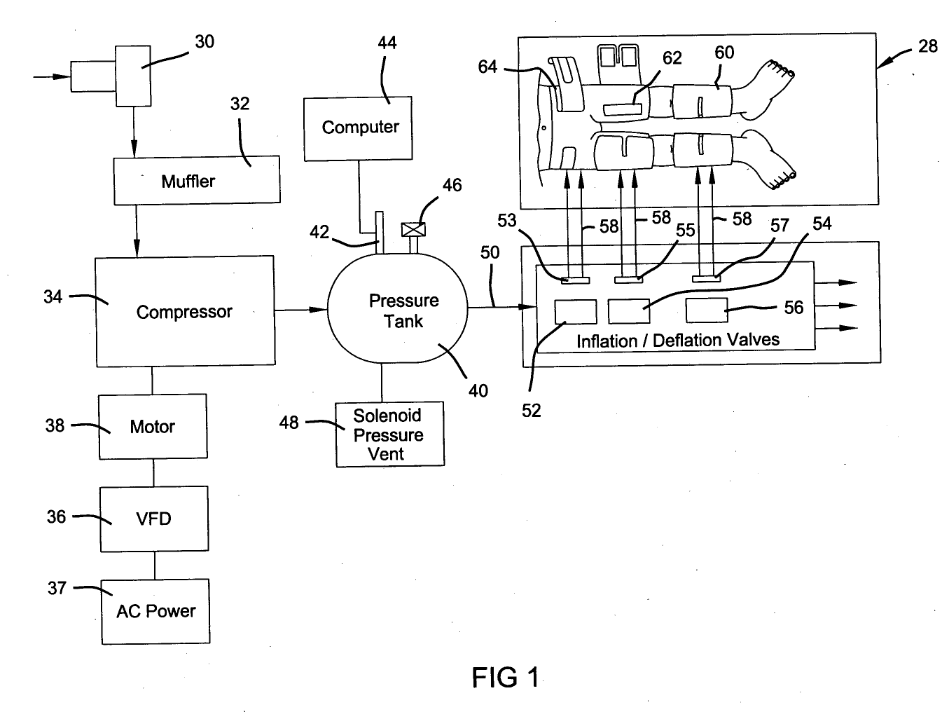

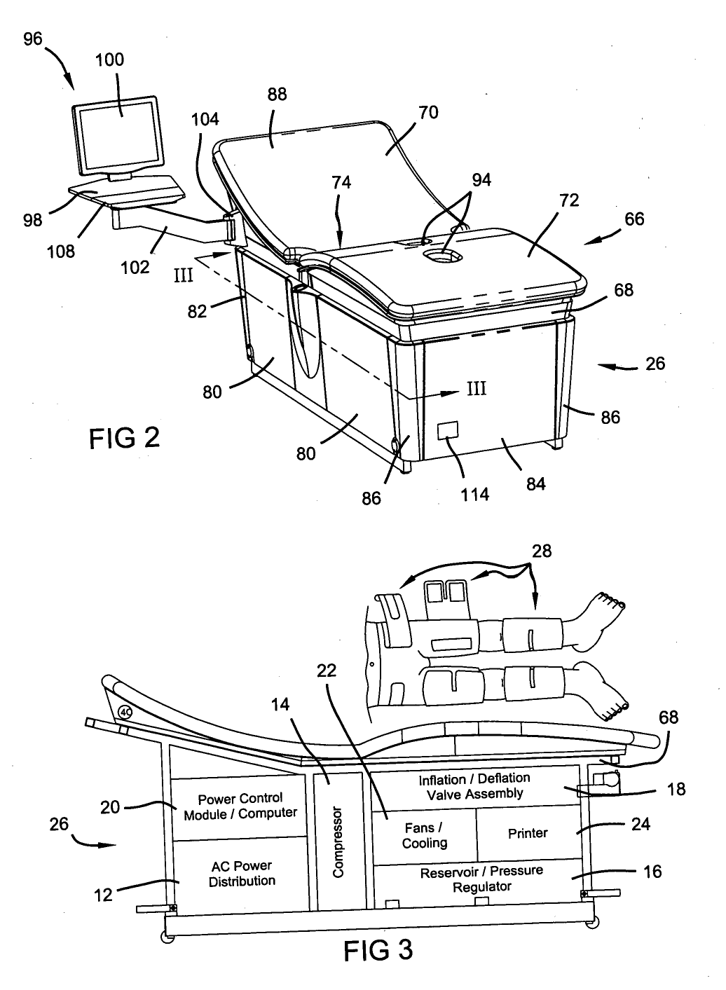

FIG. 1 is a diagrammatic view of an external counterpulsation apparatus according to the principles of the present invention. As depicted in FIGS. 2-5, the present invention provides an external counterpulsation treatment system having all of the system components internally housed within one treatment table assembly unit. It will be understood from the description that follows, the present invention provides benefits to the long felt need of increased efficiency and ease of use. The present invention provides a stable treatment table having modular components that reduces space requirements, improves mobility, enhances inflation and deflation rates, reduces noise and heat generation, and operates with reduced pressure loss during treatment. As used herein, a “modular” component is one that can be taken out as an individual component unit from the treatment assembly as a whole. Preferably, certain components are designed and manufactured with standardized units or dimensions, for ease of assembly, maintenance and repair, flexibility of arrangement, general use, and long distance transportation of the assembly. It should be understood that unless otherwise noted, any location of a modular component is for illustrative and discussion purposes, and it is not intended to imply that the arrangement shown or discussed is the only arrangement or configuration.

External Counterpulsation Method:

The methods of the present invention include administering external counterpulsation to a human or other animal subject. As referred to herein, “treatment” includes effecting a long-term physiological improvement in cardiac function, as well as symptomatic improvement, in a subject. Administering external counterpulsation (herein “ECP”) to a subject includes applying external pressure to an extremity of the subject so as to create retrograde arterial blood flow and enhanced venous return from the extremity to the heart of the subject during diastole (i.e., the period of relaxation of the left ventricle of the heart). Preferably, the extremity comprises one or more of the legs of the subject, in a human subject preferably including both legs and/or both arms. In another embodiment, extremity in a human subject comprises both legs, more preferably including the calves, thighs, and upper thighs, and buttocks of the subject. In a preferred embodiment, the external pressure is applied using a plurality of pressure devices applied to the extremities of the subject, and inflated and deflated in synchrony with the cardiac cycle of the subject so as to create a pulse of arterial blood that arrives at the heart essentially at the end of the ejection phase of the left ventricle and closure of the aortic valve. In a preferred embodiment, the administration of optimized ECP is performed using an optimized ECP apparatus, preferably as described herein. As used herein, the words “preferred” and “preferably” refer to embodiments of the invention that afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

Preferably, optimized ECP is administered on at least about fifty (50) percent of the days of the treatment period (i.e., on at least about forty (40) days of an eighty (80)-day treatment period), more preferably on at least about seventy (70) percent, more preferably at least about eighty-five (85) percent, of the days of the treatment period. Preferably, optimized ECP is administered at least four (4) days during every seven (7)-day period of the treatment period, such that there are no more than three (3) consecutive days in which optimized ECP is not administered. More preferably, optimized ECP is administered at least five (5) days, even more preferably at least six (6) days, during every seven (7)-day period during the treatment period. Preferably, optimized ECP is administered for from about thirty (30) minutes to about two hundred (200) minutes for each day during which treatment is administered, preferably from about sixty (60) minutes to about eighty (80) minutes per day of treatment. Preferably, the daily administration of optimized ECP is performed in one or more sessions, for from about twenty (20) to about ninety (90) minutes, preferably for from about forty-five (45) minutes to about sixty (60) minutes, more preferably for about sixty (60) minutes per session. As referred to herein, a “session” of optimized ECP comprises the repeated inflation and deflation of pressure devices in synchrony with the cardiac cycle of the subject in a substantially continuous manner. Preferably from one (1) to three (3), more preferably one (1), session is conducted during each day in which optimized ECP therapy is administered. A preferred method comprises from one (1) to three (3) sessions of optimized ECP therapy during each day of at least four (4) days of every seven (7)-day period during a treatment period of from about twenty (20) to about sixty (60) days.

Optimized ECP accomplishes many hemodynamic effects including: lowering end diastolic pressure to initiate left ventricle ejection earlier, reducing energy spent in isovolumetric contraction and giving more energy to ejection to increase cardiac output; and increasing velocity of circulating the blood, both antegrade and retrograde, to increase sheer stress on endothelial cells. These hemodynamic effects are characterized as follows:
(a) increased venous return;
(b) increased diastolic filling;
(c) increased stroke volume;
(d) generating retrograde arterial pressure or flow pulse;
(e) increasing diastolic pressure;
(f) increasing coronary blood flow;
(g) enhancing coronary collateral circulation development;
(h) increasing whole body mean perfusion pressure;
(i) reducing peripheral resistance;
(j) creating “suction effect” by releasing external pressure on vascular space previously compressed;
(k) creating systolic unloading; and
(l) increasing cardiac output without increasing systolic pressure.

Two effects of counterpulsation, namely, increased cardiac output and systolic unloading, are in conflict with each other. The more improvement in cardiac output optimized ECP can achieve, the harder it is to reduce systolic pressure. More particularly, due to increased venous return, increased cardiac output increases systolic pressure because of the pressure-volume relationship in the aorta. Under normal conditions, a stroke volume (i.e., the volume of blood that is pumped out during each heartbeat) of fifty (50) milliliters of blood would raise the aortic pressure from a diastolic pressure of eighty (80) millimeters Hg to a systolic pressure of one hundred twenty (120) millimeters Hg. If the stroke volume increased forty percent to seventy (70) milliliters, the systolic pressure should be one hundred thirty-six (136) millimeters Hg, making systolic unloading difficult to achieve.

This conflict can be partially resolved as long as the peripheral vascular space that has been compressed before is large enough to produce the suction effect to receive the increase cardiac output. Thus, optimized ECP compresses as much peripheral vascular tissue as possible. There is a limit, however, to the peripheral artery space, and it is usually smaller than the venous space. Therefore, as ECP performance is optimized, systolic pressure may not be significantly reduced.

But the reduction in systolic pressure during optimized ECP may also be understated as a result of the way in which it is measured. This can be further explained by examining a normal heartbeat wherein the heart pumps out blood during systole causing blood pressure to increase from diastolic pressure (usually eighty (80) millimeters Hg) to peak systolic pressure (usually one hundred twenty (120) millimeters Hg). For this example, a stroke volume of fifty (50) milliliters produces a rise of forty (40) millimeters Hg in the aorta (to about one hundred twenty (120) millimeters Hg from eighty (80) millimeters Hg). Assuming a linear relationship between volume and pressure, the larger the volume of blood being pumped out of the heart, the greater the rise in systolic pressure. For this same normal heartbeat during optimized ECP, because venous return increases, the stroke volume will generally increase about thirty (30) percent to fifty (50) percent. If there is an increase of fifty (50) percent, then a non-optimized ECP stroke volume of fifty (50) millimeters becomes an optimized ECP stroke volume of about seventy-five (75) millimeters. This appears as a rise of sixty (60) millimeters Hg from normal diastolic pressure, giving a systolic pressure of about one hundred forty (140) millimeters Hg.

But during optimized ECP treatment, a slight reduction of systolic pressure to one hundred ten (110) millimeters Hg is typical, at least implying that the systolic pressure is actually reduced from one hundred forty (140) millimeters Hg to one hundred ten (110) millimeters Hg, a significant reduction. However, because the observed systolic pressure without optimized ECP is one hundred twenty (120) millimeters Hg, a systolic pressure of one hundred ten (110) millimeters Hg during optimized ECP—a reduction of only ten (10) millimeters Hg instead of thirty (30) millimeters Hg—might lead to an erroneously conclusion that systolic reduction is not significant during optimized ECP.

Even though it is advantageous to reduce systolic pressure to give the heart a rest, increasing cardiac output, blood flow velocity, circulation and endothelial cell shear stress also improve cardiac function, i.e., by increasing release of nitric oxide (NO₂) and reducing vascular resistance. As mentioned above, increasing cardiac output and systolic unloading may be in conflict when using the same inflation/deflation times and applied pressure. In this circumstance, shifting the emphasis from systolic unloading to maximal reduction of end diastolic pressure augments cardiac output by redistributing the increased energy supply from diastolic augmentation so that less energy is spent in left ventricular isovolumetric contraction, and more energy is spent ejecting the larger volume of blood returned to the heart due to increased venous return. In this way optimized ECP differs from other counterpulsation techniques such as intraaortic balloon pumping (IABP) because such other techniques do not increase venous return; therefore, there is no need to reserve the extra energy to pump out the extra volume returned to the heart.

Thus, systolic unloading is not necessarily an objective of optimized ECP, unlike maximizing diastolic augmentation and minimizing end diastolic pressure. Optimized ECP, therefore, seeks to minimize end diastolic pressure (governed by deflation timing, i.e., determining the appropriate time in the cardiac cycle to remove applied pressure), and to maximize diastolic augmentation (governed by inflation timing, i.e., determining how to cause the retrograde pulse to arrive at the root when aortic valve closes and how long it is held in relationship to deflation time). The use of sequential application of pressure to the patient's limbs further helps achieve these objectives.

Features employed to increase cardiac output, blood flow velocity, circulation and shear stress on the endothelial cells, and thereby improve cardiac output include: Timing inflation and deflation to minimize end diastolic pressure and maximize diastolic pressure; controlling the magnitude of externally applied pressure to maximize emptying of vasculature under external pressure; controlling the rate of application of external compression; controlling the rate of deflation of external compression; controlling the volume of peripheral tissue under compression; sequentially timing inflation from distal to proximal portions of body to milk blood back to the heart; controlling the gradient of applied pressure from distal to proximal portions of body to reduce the leakage of blood back to distal portion; and applying pressure uniformly in each section (cuff) along the length of the body.

Optimized ECP Apparatus:

Preferably, administration of optimized ECP is performed using an optimized ECP apparatus (herein, “optimized ECP apparatus”), including (a) one or more pressure devices that are applied to an extremity of the subject; (b) a device for inflating and deflating the pressure devices; and (c) a controller that initiates inflation and deflation of the pressure devices in synchrony with the cardiac cycle of the subject. An exemplary optimized ECP apparatus is generally referred to by reference numeral 10 and is depicted with an isometric view in FIG. 2. The unitary and curvilinear external counterpulsation assembly includes three basic and internally housed component assemblies, namely: a curvilinear treatment table assembly; inflatable pressure devices; and control console assembly, preferably including a device for inflating and deflating the pressure devices and a computerized controller that initiates inflation and deflation of the pressure devices.

FIG. 3 depicts a cross sectional view of the treatment table assembly taken along the line III-III of FIG. 2. The unitary assembly 10 provides for the proximal placement of an AC power module and supply distribution means 12, a compressor 14, a reservoir 16, an inflation and deflation valve assembly 18, a power control module 20 which may include various electronics and a computer, fans and cooling devices 22, and a printer 24 all in an integrated housing unit 26. The housing unit provides a plurality of modular compartments, each operable to house treatment system components and adapted to be individually removed for service and mobility. This all-in-one assembly provides improved mobility, reduces unnecessary pressure and energy losses, power requirements, and heat and noise generation. Preferably, the placement of the inflation/deflation assembly directly beneath the patient reduces dead space and less energy is needed to achieve the required pressure during the diastolic phase of the treatment. The rate of inflation is increased without loss in transmission through long connecting tubing, and the rate of deflation is faster with reduced residual pressure.

The optimized ECP apparatus preferably comprises inflatable pressure devices 28 that are applied to the legs or other limbs of the subject, preferably to the calf areas, thigh areas and buttocks of the subject as shown in FIGS. 1 and 3. Such pressure devices apply pressure to the patient's limb using, in a preferred embodiment, a bladder that is inflated with a fluid, preferably air. Preferably the pressure device comprises a bladder and a fastener that holds the bladder against the limb, so that when the bladder is inflated, pressure is applied to the limb. In a preferred embodiment, the fastener comprises a cuff body that holds the bladder against the limb, preferably a cuff surrounding a bladder. Preferably, each bladder applies from about one hundred forty (140) to about three hundred twenty (320) millimeters Hg of pressure to the limb. The fastener is made, for example, from materials including vinyl, leather, cloth, canvas, and rigid or semi-rigid materials such as plastic or metal. Different sizes of bladders and fasteners may be provided to meet the requirements of different body shapes. Preferably, space between the fastener and the bladder and between the bladder and the limb is minimized. A preferred pressure device comprises a substantially rectangular shaped bladder. Also, preferably, the upper and lower thigh pressure devices are a one-piece design to prevent the lower thigh pressure device from sliding during treatment. It should be understood, however, that numerous combinations of pressure devices can be used as desired.

The optimized ECP apparatus 10 also preferably comprises a device for inflating and deflating the pressure devices 28 using a fluid, such as air. In a preferred embodiment, where the pressure devices 28 are inflated with air, the inflating and deflating device comprises a compressor and an air distribution mechanism that operates to distribute the air from the compressor to the pressure devices. FIG. 1 depicts a preferred embodiment of the compressed fluid (preferably compressed air) flow arrangement for the optimized ECP apparatus 10. The apparatus generally includes an air intake/filter assembly 30, one or more mufflers 32, which can be located before or after a compressor assembly 34, which includes a power supply, preferably an AC power supply connected to a variable frequency drive device 36 in communication with a motor 38, a pressure tank 40, a pressure sensor/transducer assembly 42 including a computer 44 or controller 20, a pressure safety relief valve 46, and a solenoid pressure vent 48. A temperature sensor may also be included (not shown).

A hose connection assembly 50 is used for quick connecting and disconnecting the above-described components with those mounted on, or otherwise associated with, an assembly including valves that individually control inflation and deflation of the pressure devices. In a preferred embodiment, the valve assembly 18 is part of a treatment table assembly 10 as shown in FIG. 2. Such treatment table valve assembly 18 components include a valve manifold and a number of sequentially operable inflation/deflation valves 52, 54 and 56. Each valve 52, 54, 56 may have an associated pressure transducer/sensor 53, 55, and 57, respectively. An optional connect/disconnect assembly 58 is provided for quick and easy connection and disconnection of the inflation/deflation valves with associated pressure devices, e.g., the calf pressure devices 60, lower thigh pressure devices 62, and upper thigh pressure devices 64, respectively. In one embodiment, the inflation/deflation valves 52, 54 and 56 are a rotary actuable butterfly-type valve, which can be actuated pneumatically or electrically. In another embodiment, the valve assembly is part of a separate console, and the patient may lie on any suitable table or bed.

As compared with prior art systems having a separate control console, the present invention preferably has the inflation/deflation valves assembly placed directly under the patient, as close to the extremities as possible. Any dead space is reduced and less energy is required to achieve the required pressure in the compression, or diastolic phase. Thus, the rate of inflation is increased, and is further without any loss in transmission through unnecessary long connecting tubing. Most importantly, because the deflation valves are located in such a close proximity to the patient, the rate of deflation is increased and with reduced residual pressure. This is a very important feature, as any residual pressure larger than 20-30 mm Hg may compress on the venous side of the vascular and reduce the hemodynamic effectiveness of ECP altogether.

Patients undergoing ECP require a stable treatment table to lie upon. The need for such a stable table arises from the overall movement of the patient's body during the treatment. During counterpulsation, the inflation and deflation valves 52, 54, 56 are rapidly opened and closed and a large amount of compressed fluid rushes in and out of the cuffs or pressure devices 28 wrapped around the limbs of the patient in a very short time period (about 50-100 ms) inducing a variety of motions of the limbs. An unstable treatment table would amplify these motions, not only causing patient discomfort and/or motion sickness, but the motion would produce motion artifacts on the electrocardiogram (ECG) and would affect other physiological measurements such as SpO₂, blood pressure and blood flow, making the detection of a physiological triggering signal, such as ECG, for the synchronization of counter pulsation with the cardiac cycle practically impossible. The present invention addresses these concerns by placing all of the treatment system components in a stable table assembly, with or without an adjustable height.

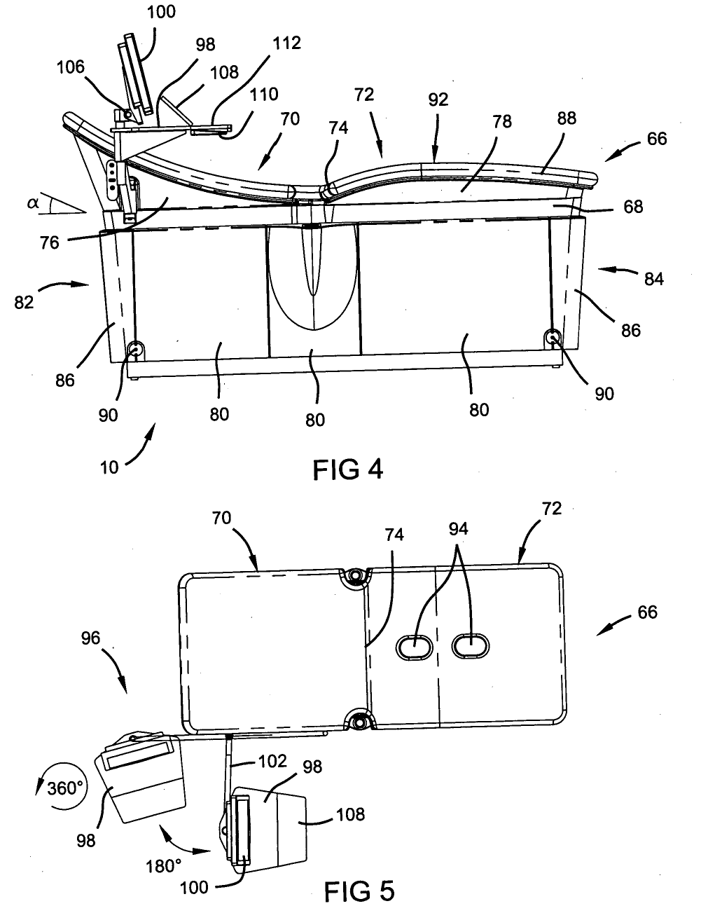

In one preferred embodiment, the counterpulsation apparatus of the present apparatus has a curvilinear shaped tabletop 66, or bed, for treatment as shown in FIGS. 2-4. This wave-like curved design permits a patient to lay in a restful and comfortable position which corresponds to the natural contours of the human body. As depicted in FIG. 4, the curvilinear treatment table 66 preferably comprises a support surface or frame 68 having an upper portion 70 and a lower portion 72 joined at a saddle point 74. The frame 68 is preferably made with sheet metal and welded aluminum. The upper portion 70 of the table 66 is contoured with an upper bedform 76 having a substantially concave shape, that operates to support the head and upper torso area of a patient. The lower portion 72 of the table 66 is contoured with a lower bedform 78 having a substantially convex shape, that operates to support the lower torso area of a patient. The bedforms 76, 78 are preferably molded high-density polyethylene (HDPE) or another suitable material capable of supporting the weight of a patient during treatment. The two portions 70, 72 are preferably hingedly or otherwise pivotably interconnected at the saddle point 74. The upper portion 70 is design with the capability to articulate to certain angles for patient comfort. Alternatively, the two portions may be formed using a one-piece configuration. The lower half 26 of the treatment assembly is enclosed with respective side panels 80, a front panel 82, rear panel 84, and corner panels 86.

A removable, one or two-piece cushion or mattress 88 is secured on the upper and lower portions 70, 72. In one preferred embodiment, the mattress includes an open cell polyurethane foam or a visco-elastic memory foam for added patient comfort. Preferably the mattress has a comfortable foam that responds to the body's temperature and then conforms to the body's shape. As the memory foam conforms to the shape of the body, the pressure points that normally develop from lying on flat surfaces are significantly reduced. The body's weight is redistributed so that more of the body is in contact with the mattress surface. This decreases pressure points, increasing circulation and supporting the spine in a more natural position. Preferably, the mattress 88 includes additional perimeter support to help prevent the patient from sliding off of the bed. The mattress 88 is preferably covered with a vinyl cover. Additionally, the cover may optionally have areas with an anti-slip surface (not shown), such as a grip tape or a specialty fabric with a rubberized coating operable to grippingly engage the patient further preventing the patient from sliding during treatment.

Some patients utilizing counterpulsation treatments have additional health concerns, such as congestive heart failure, which prohibit them from lying on a flat surface for an extended period of time. The present invention additionally permits the patient to lay in an angulated position while not requiring the use of additional pillows or support members. Preferably, the lower portion 72 is stationary, and the upper portion 70 is articulatable for adjustment, either manually or by way of a power drive mechanism, to a plurality of horizontally angulated positions relative to the saddle point 74. The angulated position of the upper portion 70 relative to the saddle point 74 and lower portion 72 is preferably limited to an inclination angle α that is from about 10° to about 30° above the horizontal. More preferably, angle α provides an inclination of about 15° above the horizontal. Preferably, the treatment table 66 is provided with an elevation assembly (not shown) including a motor to raise and lower the overall height of the bed. Also, preferably, the treatment table assembly is configured for mobility, e.g., having wheels 90, allowing easy movement from one location to another.

As depicted in FIGS. 2-4, the saddle point 74 of the curvilinear table 66 is preferably positioned lower than both the upper and lower portions 70, 72. This provides a convenient place for the patient to initially sit down on the table and subsequently raise and rotate his or her lower torso, legs and feet up and onto the lower portion 72. This point also provides a natural position for the patient to settle down into during treatment, as the potential for sliding movement is often increased when the upper portion 70 is in an inclined position. The convex shape of the lower bedform 78 provides a raised area below the saddle point and serves to help minimize and prevent the patient from sliding down the table. Additionally, the calf area and feet of the patient are preferably supported by the highest point 92 of the lower portion 72 of the table 66. This elevation makes it easier for the operator or clinical personnel to situate the patient and connect the necessary cuffs and inflatable devices 28 in preparation for treatment. Preferably, the mattress 88 and bedform 78 of the lower portion 72 include at least one aperture or opening 94 adapted to provide a passageway for connecting tubes between the inflatable pressure devices 28 to the inflation and deflation assembly 18 as shown in FIGS. 2, 3 and 5.

The optimized ECP apparatus also preferably comprises a controller 20 that initiates inflation and deflation of the pressure devices in synchrony with the cardiac cycle of the subject. In a preferred embodiment, the controller 20 is part of a control console assembly. As depicted in FIGS. 1, 2, 4 and 5, one control console assembly embodiment generally includes a computer 44, a user interface device 96, such as a computer monitor or touch screen for displaying physiological signals from the patient during treatment. The computer may be located in a cabinet or housing area for the control module 20, in which various system components are located and housed. The control console assembly preferably includes a power supply 12 that feeds power to the computer 44 and the compressor assembly 34, by way of a power switch panel, transformer, or power module, which includes a power converter and ramp-up assembly.

As shown in FIGS. 2, 4 and 5, the user interface 96 preferably includes a work surface area 98 with a touch screen monitor 100 for easy monitoring of patient treatment status, treatment parameters, and other relevant physiological signals or data, and provides the capability for adjustment and controlling the treatment and operation proceedings. Preferably, the work surface 98 is side mounted to either side of the ECP treatment apparatus 10 with an arm 102 hingedly secured to an arm mount 104 for coordinated movement therewith, preferably having up to a 180 degree swing. It should be understood that the user interface 96 could be mounted in any manner convenient with the overall design and operation of the assembly. The monitor 100 is preferably mounted to the work surface 98 via a monitor mount 106, or other suitable means. The work surface 98 preferably has a flip-top portion 108 with a recessed area 110 suitable to house a keyboard 112 if so desired. In addition to the hinged arm 102, preferably the work surface 98, together with the monitor, 100 can be rotatably mounted to the arm allowing a full 180-360 degree rotation in addition to the swing arm 102 movement.

In one embodiment, an internally housed computer 44 monitors and records information associated with the treatment of the patient. Alternatively, another computer or remote computing system can be used to monitor and record information associated with the treatment of one or more patients.

According to this aspect of the present invention, a first microprocessor controller controls the operation of external counterpulsation by taking a patient's physiological signals as a trigger to synchronize the application of external pressure to the cardiac cycle with appropriate inflation and deflation timings, and communicates these operational parameters to a second microprocessor controller serving as an interface between the ECP operation and the operator, displaying operational parameters on screen, receiving inputs from the operator to change the treatment parameters if necessary. The local computer also serves as data input and storage, storing both patient treatment parameters and treatment effects, as well as patient data input from the operator including patient identification, medical history, diagnosis, prior treatment data and medications. It can also generate a patient treatment report, either on the daily treatment session (usually one hour daily) or an integrated summary report of the total treatment sessions (usually between 30-36 hours over a seven week period). This can be sent to a printer for record or for submission to a medical insurance provider for reimbursement of treatment provided.

The local computer can also be loaded with software used for training operators. It can generate an electrocardiogram (ECG) at various heart rates, produce abnormal cardiac rhythms such as premature ventricular contraction (PVC) or atrial fibrillation, generate motion artifacts on the ECG, and stimulate the corresponding blood pressure waveforms during control and under ECP treatment with different waveforms for various input of inflation times and deflations. The communication between the local computer located in the ECP system and an external computer or facility network can be through a remote terminal to monitor the progress of the treatment, to share patient data with the local ECP computer, to store ECP treatment parameters and treatment effects, and to generate patient treatment reports to be filed as a record of treatment.

As shown in FIGS. 1-3, preferably, the ECP assembly includes a printer with an external printer panel 114 or other suitable means of outputting patient data, treatment protocol, and treatment results. The user interface 96 also preferably provides switches or touch screen display links to the computer for adjusting the timing of the inflation/deflation cycle, allowing the operator to adjust the setting of the time for the start of sequential inflation as it is measured relative to the R peak of the treated subject's ECG signal, as further described below.

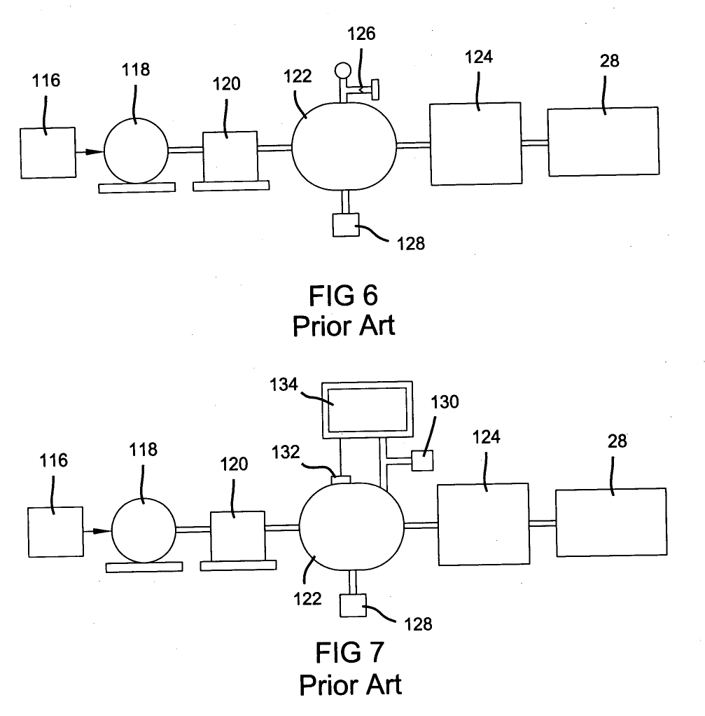

An important parameter in external counterpulsation affecting safe and effective treatment is the magnitude of the pressure applied to the extremities of the patient. A pressure too high, above 250-300 mm Hg, may produce trauma to the skin, muscle, bones and vasculature. A pressure too low, less than 100-200 mm Hg, generally will not compress the peripheral blood vessels for effective treatment. The ability to appropriate pressure depends not only on the predetermined setting, but also on the ability to maintain the same pressure from any variation in the heart rhythm or other environmental variable. Prior art external counterpulsation devices use pressure regulators, as shown in FIG. 6. AC power 116 is supplied to power a 1.5-2 horsepower motor 118 which turns a compressor 120 and outputs a constant volume of compressed air at a pressure set by the pressure release valve which defines the upper applied pressure limit to the inflatable devices 28, assuming there is no pressure loss between the reservoir 122 and the inflation/deflation valves assembly 124 in communication with the cuffs, or inflatable devices 28. The actually applied pressure is adjusted by turning the needle adjustable leak valve 126 during the treatment. In order to produce the required preset pressure to the inflatable devices, the volume of compressed air injected into the inflatable devices 28 (Vₚ) is equal to the output volume of the compressor plus the volume of any leaks through the pressure relief valve 128 and the needle adjustable leak valve 126. Since Vₚ is dependent on the heart rate (HR) and the size of the patient (i.e. a higher HR or a larger patient require more compressed air), the compressor and motor must be selected having continuous operation for the largest patient (greater than 350 lb) with the highest HR (greater than 120 bpm). This is rarely the common patient, thus when smaller patients with slower heart rates are treated, a large portion of the compressor output is leaked through the pressure release valve 128 and needle adjustable leak valve 126, thereby wasting power, and producing excess heat and noise.

In the older assemblies as depicted in FIG. 6, the needle adjustable leak valve 126 was manually set, and often failed to follow the rapid HR variations, especially with patients having abnormal heart rhythms, possibly due to premature ventricle contraction, or atrial fibrillation. As shown in FIG. 7, this has been improved by the replacement of the needle adjustable leak valve 126 with a pressure control valve 130, such as a servo-proportional valve using a signal from an electrical transducer 132 in a closed-loop feedback application monitored by a CPU 134.

The improvement of using an electrical pressure control valve allows the operator to digitally adjust the preset reservoir pressure, and enables the quick response to variations in pressure due to changes in the demand of compressed air. This improvement, however, still requires a constant output from the compressor, which is designed to supply enough compressed air for a large patient having a high HR, commonly 20-22 cubic feet per minute at about 6 psi. When average to smaller size patients, or patients having a lower HR are treated, the excess compressor output is vented through the pressure control valve and pressure release valve. In addition to the increased noise, heat, and energy requirements, this design has costly components and control circuitry, and requires specialized electrical wiring.

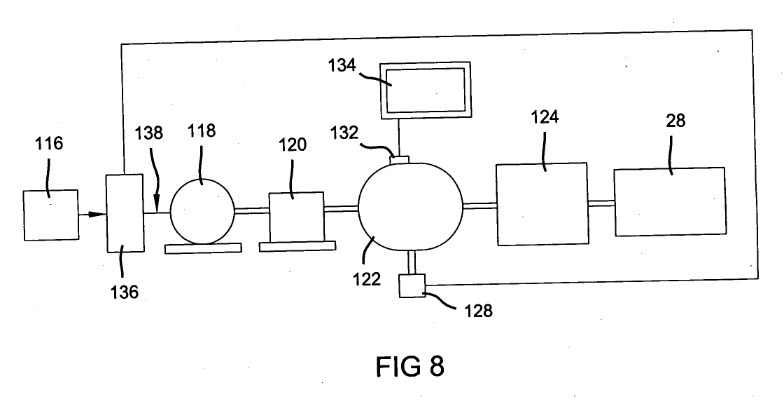

In one preferred embodiment of the present invention, as shown in FIG. 8, an apparatus and method are provided to regulate the pressure applied to the lower extremities of the patients through the use of a variable frequency drive device 136, such as a transistorized inverter, that produces a variable frequency AC power supply to the motor, which in turn, generates a variable revolutionary speed turning the compressor. The variable frequency drive device is adapted to cooperate with a control module to direct the generation of compressed fluid at a variable output with a pressure and rate corresponding to the patient's physical and physiological operational parameters. In one embodiment, the output of the compressor is controlled such that the volume output is equal to the volume of compressed air required to produce a preset pressure in the inflatable devices.

The AC power supply can be 100-120V or 220V, 50 or 60 Hz, 1 or 3 phase. It is connected to the input side of the inverter. The variable frequency inverter output 138 is connected to the motor input. When initially powered on, the power output of the inverter is ramped-up by slowly increasing the frequency of the output power to the motor. This provides numerous advantages. First the performance of the motor will be independent of the frequency of the AC power supply. This allows the present invention to be used in different countries having different power supply frequencies. Preferably, the present invention further includes a power ramp-up device that upon startup of the ECP apparatus converts electrical power to the compressor from 110/120 or 220 VAC 50/60 Hz, one or three-phase, to three-phase 220 VAC at a variable frequency and increases the electrical power to a pre-selected full power level over a period of about three to about five seconds. The ramp-up feature reduces the sudden requirement of power, often in excess of 20 amperes, upon initial startup of the device, reducing the possibilities of overloading the power supply.

More importantly, the present invention provides a method to control the pressure applied to the inflatable devices without the use of pressure control valves. The output of the compressor is controlled via the variable frequency drive device 136, which supplies an adjustable frequency of alternating current 132 to control the speed of the AC motor 118 which can be described by the following relationship: N=120*F/p; where N is the speed of the motor (rpm), 120 is the electrical constant, F is the frequency (Hz) of the alternating current, and p is the pole of the motor (typically valued at 2, 4, or 6). For example, a common 60 Hz AC power line with a 2 pole motor would have a speed of approximately 3,600 rpm. The volume of compressed air generated by the compressor is proportional to the speed of the motor. Therefore, by controlling the line frequency of the motor, the apparatus can control the output of compressed air from 0 to about 80 Hz, or 133% of the output of a compressor powered by a 60 Hz AC power line. While a frequency greater than 60 Hz may be taxing on the motor and compressor for prolonged use, it is a beneficial feature when temporary extraordinary demand may be required, and its occasional use is not harmful.

The present invention, therefore, eliminates the requirement of running the motor and compressor at full capacity during the operation of counterpulsation treatment for different patients. This conserves energy, reduces the generation of heat and noise, and prolongs the life of the motor and compressor. Additionally, it permits the use of the system components in various countries without requiring additional components to correspond with the varying input power line frequencies.

In another preferred embodiment of the present invention, an optimized ECP apparatus is provided having different size inflation/deflation valves. The anatomy of each patient is different, including the patient's calf size, lower and upper thighs, and buttocks. Therefore, the volume of compressed air required to flow into each cuff/bladder is also different, although somewhat predictable with a pressure gradient of a few mm HG from the distal calves to the proximal upper thighs. Adding to the complexity of a predictable pressure gradient, however, is that the driving pressure from the reservoir may change depending on the size of the reservoir and the size of the compressor used. As the calf inflation valves 56 are opened, the pressure in the reservoir begins to drop, and unless the compressor has a duty equal to or greater than the required output, when the lower thigh 54 and upper thigh or buttocks inflation valves 52 open, the reservoir pressure will be progressively lower with each successive opening. This problem can be addressed by providing a large enough reservoir and powerful enough compressor so that the rate of output of compressed air is a small fraction of the volume of compressed fluid in the reservoir. This reduces the substantial drop in pressure when successive inflation valves are open. In addition, since the volume of each calf bladder 60 is generally less than the volume of each lower thigh bladder 62, which in turn is generally less than the volume of the upper thigh bladder 64, the flow rate into the calf bladders should consequently be less than the lower thigh bladders, which also may have a lower flow rate than the upper thigh bladders.

The flow rate into each inflatable device, however, cannot be controlled simply by providing a high powered compressor or a large reservoir. Prior art ECP apparatuses use the same inflation/deflation valves for the calves, thighs and buttocks. The present invention provides calf inflation valves having a lower flow rate than the lower thigh inflation valves, which further have a lower flow rate than the upper thigh inflation valves. Since the volume of air required in the calf devices is about half that of the other devices, that flow rate should be about 50 to about 70 percent of the other valve flow rates. In one preferred embodiment, the flow rates are varied by providing inflation/deflation valves having varying diameters. For example, the diameter of the calf inflation/deflation valve may be about 50 to about 70 percent of the size of the thigh inflation/deflation valve, and so forth. In another embodiment, the flow rates for all of the valves may be adjustable, either manually, by computer control, or by other means as is known in the art.

In yet a further aspect of the present invention, the use of a single plethysmographic probe is contemplated for the monitoring of the inflation and deflation timings, as well as for monitoring the hemodynamic effects of ECP and blood-oxygen saturation SpO₂. Control of external counterpulsation operation depends on the input of physiological signals from patients. The common signal for synchronization with the cardiac cycle is the electrocardiogram (ECG). The R-wave of the ECG signal is used as a trigger signal to initiate the counterpulsation cycle, indicating the heart is in its systolic phase for ejection of blood. The hemodynamic objectives of external counterpulsation are to compress the lower extremities at such a time that the blood being squeezed out of the lower extremities would arrive at the root of the aorta just at the end of systole when the aortic valve is beginning to close, and the external pressure is relieved when the blood ejected by the heart during the ejection systolic phase just reaches the proximal site of compression, the upper thighs. These physiological events are best monitored by measuring blood flow at the root of the aorta to provide information on the precise timing of the application and release of external pressure. However, blood flow at the root of the aorta is not easily measured non-invasively, if at all possible. The use of ultrasound duplex echocardiography can sometimes be performed if motion artifacts during counterpulsation can be minimized. In any case, however, it is time consuming and not reliable. The next best physiological signal to measure for proper adjustment of inflation/deflation timing and monitor the hemodynamic effects of external counterpulsation is a beat-to-beat blood pressure waveform measurement. The ideal location of measurement should be at the root of the aorta, but as previously discussed, this is difficult to obtain without invasive means. One alternative is the use of a tonometry or oscillatometry at the arm or wrist to measure the pulses of the brachial or radial arteries. These methods are time consuming and easily subject to motion artifacts produced during external counterpulsation, affecting the accuracy of the measurement.

The current practice in monitoring the timing and hemodynamic effects is the use of a fingertip photoplethysmograph that can easily be put on the fingertip of a patient with a clip. It produces a waveform that follows satisfactorily with that of a blood pressure waveform. As known in the art, infrared light emitting diodes (LED) emit an infrared ray that is partially absorbed by the hemoglobin in the artery, and the reflected light is detected by a photo sensor. The amount of reflected light is inversely proportional to the amount of hemoglobin in the volume scanned by the light, and the amount of hemoglobin present is proportional to the blood pressure. Therefore, the inverse of the output of the photo sensor would produce a waveform in close approximation of the blood pressure waveform.

External counterpulsation not only produces diastolic retrograde blood flow in the artery side of the vasculature, but it also produces increased venous return. The increased venous return may increase blood pressure in the right ventricle, inducing pulmonary hypertension, and may lead to pulmonary edema (accumulation of fluid in the lung). This must be closely monitored during treatment.

Prior art ECP apparatuses have used a blood oxygen detector means for monitoring the blood oxygen saturation of the patient during counterpulsation. A pulse oximeter can be used as such a blood oxygen detector. It is a simple, non-invasive method of monitoring the percentage of hemoglobin (Hb) which is saturated with oxygen. The pulse oximeter consists of a probe attached to the patient's finger or ear lobe which is linked to a computerized unit. A source of light originates from the probe at two wavelengths (red at 650 nm and infrared at 805 nm). The light absorption ability of hemoglobin saturated with oxygen (HbO₂) is different from those hemoglobin unsaturated with oxygen. By calculating the absorption at the two wavelengths the processor can compute the proportion of hemoglobin which is oxygenated. The unit displays the percentage of Hb saturated with oxygen. The oximeter can also detect the pulsatile flow and produce a graph as a fingertip photoplethysmograph.

It is therefore an added safety feature of the present invention to incorporate monitoring of the percent of blood partial oxygen saturation (SpO₂) during external counterpulsation, especially for treatment of patients with congestive heart failure. Current state-of-the-art external counterpulsation treatment devices use two separate finger probes, one for the photoplethysmograph monitoring inflation/deflation timing and the hemodynamic effects of the treatment, and one for the oximetry monitoring the level of SpO₂ in the blood to avoid pulmonary congestion. It is an object of the present invention to combine these two probes into one, so as to simplify the operation of the equipment, reduce error and improve the overall safety of the treatment.

This object of the invention uses the same operational principles of having a separate photoplethysmograph and oximeter in the absorption of infrared light by hemoglobin, but accomplishes this through the use of a single probe. The single probe monitors the waveform of the arterial pulse for use in timing the application and release of external pressure to the lower extremities, while at the same time monitors the percent oxygen saturation in the blood to avoid inducing pulmonary congestion or edema in the lung during treatment. Preferably the probe is in communication with the controller, and determines if and when the saturation level falls below a safe level determined pursuant to sound medical practice. Such a level may be set by the service provider, or be automatically determined by the optimized ECP apparatus. In one embodiment, the controller terminates therapy if the blood oxygen levels fall below the safe level. In another embodiment, the controller provides a visual or audible signal to the clinical personnel or service provider.

The examples and other embodiments described herein are exemplary and not intended to be limiting in describing the full scope of compositions and methods of this invention. Equivalent changes, modifications and variations of specific embodiments, materials, compositions and methods may be made within the scope of the present invention, with substantially similar results.

What is claimed is:

1. An external counterpulsation apparatus for treating a patient, the apparatus comprising:
a treatment table assembly comprising a bed, a housing unit, and a fluid distribution assembly operable to apply pressure to limbs of the patient;
a sensor monitoring patient treatment data;
a first microprocessor controller disposed in said housing unit and adapted to process said patient treatment data and control the application of pressure through said fluid distribution assembly; and
a second microprocessor controller external to said housing unit, in communication with said first microprocessor controller, and operable to output data to a human operator.

2. An apparatus according to claim 1, wherein said second microprocessor is adapted to process data selected from the group comprising: treatment parameters, treatment effects, patient identification, medical history, diagnosis, prior treatment data, and medications.

3. An apparatus according to claim 1, further comprising a plethysmographic probe operable to detect patient treatment data selected from the group comprising: monitor inflation and deflation timings, hemodynamic effects, and blood-oxygen saturation.

4. An apparatus according to claim 3, wherein said second microprocessor controller is operable to execute training software.

5. An apparatus according to claim 1, wherein said second microprocessor controller is operable to output data selected from the group comprising: an electrocardiogram at various heart rates, an abnormal cardiac rhythm, motion artifacts, blood pressure waveforms, and health insurance treatment reports.

6. An apparatus according to claim 1, wherein said first and second microprocessors communicate with one another through a remote terminal.

7. An apparatus according to claim 1, further comprising a variable frequency drive device, wherein said fluid distribution assembly includes a plurality of inflatable devices adapted to be received about the lower extremities of a patient, said variable frequency drive device adapted to cooperate with said first microprocessor to vary generation of a compressed fluid and distribute said compressed fluid at a flow rate corresponding to said patient treatment data.

8. An apparatus according to claim 7, wherein said variable frequency drive device drives a motor generating said compressed fluid.

9. An apparatus according to claim 8, wherein an operating frequency of said motor is between zero and about 80 Hz.

10. An apparatus according to claim 8, wherein said compressed fluid is varied between about zero and about 133 percent of an output of a compressor using a 50/60 Hz power source.

11. An apparatus according to claim 7, wherein said variable frequency drive device includes a transistorized inverter that produces a variable frequency AC power supply.

12. An apparatus according to claim 1, wherein said fluid distribution assembly includes a plurality of inflatable devices adapted to be received about the lower extremities of a patient and a plurality of valves interconnected with said plurality of inflatable devices and adapted to deliver a variable flow rate of fluid from a source of compressed fluid to said plurality of inflatable devices.

13. An apparatus according to claim 12, wherein at least two of said valves provide different flow rates.

14. An apparatus according to claim 12, wherein said plurality of inflatable devices includes calf inflation device, a lower thigh inflation device, and an upper thigh inflation device, and wherein said fluid distribution assembly includes:
a first valve providing fluid communication between said compressed fluid source and said calf inflation device;
a second valve providing fluid communication between said compressed fluid source and said lower thigh inflation device; and
a third valve providing fluid communication between said compressed fluid source and said upper thigh inflation device,
wherein a flow rate through said first valve is less than a flow rate through said second and third valves.

15. An apparatus according to claim 14, wherein said first valve flow rate is between about 50 to about 70 percent of said second and said third flow rates.

16. An apparatus according to claim 14, wherein a diameter of said first flow valve is between about 50 to about 70 percent of a diameter of said second and said third flow valves.

17. An apparatus according to claim 14, wherein a flow rate through said second valve is less than a flow rate through said third valve.

18. An apparatus according to claim 14, wherein a diameter of said second flow valve is smaller than a diameter of said third valve.

19. An apparatus according to claim 14, wherein said valves have adjustable flow rates.
